(19) United States
(12) Patent Application Publication
(10) Pub. No.: US 2013/0329974 A1
(43) Pub. Date: Dec. 12, 2013

(54) METHOD FOR FACILITATING COMPARISON OF MEDICAL IMAGE DATA

(71) Applicants: Matthew David Kelly, Oxfordshire (GB); David Schottlander, Oxfordshire (GB)

(72) Inventors: Matthew David Kelly, Oxfordshire (GB); David Schottlander, Oxfordshire (GB)

(21) Appl. No.: 13/912,461

(22) Filed: Jun. 7, 2013

(30) Foreign Application Priority Data
Jun. 8, 2012 (GB) 1210173.9

(51) Int. Cl. G06T 7/00

(52) U.S. Cl. CPC G06T 7/0014
USPC 382/128

(57) ABSTRACT

A method for facilitating comparison of medical image data captured using first and second combinations of scanner and reconstruction protocol (‘systems’) includes using a modifier to modify image data of a first subject captured using a first system to reduce a difference from image data of a second subject captured using a second system.

### BACKGROUND OF THE INVENTION

1. Field of the Invention

The present invention concerns a method for facilitating comparison of medical image data with reference images, or with a clinician's own “mental” reference image template.

2. Description of the Prior Art

For some medical imaging procedures the reconstructed patient data can undergo standardized processing to support diagnosis. For example, following an ioflupane iodine-123 injection (DaTSCAN) SPECT, striatal uptake can be assessed on a ‘slab’ view of a patient image constructed by averaging the background-normalized uptake over the set of axial slices covering the striatum.

This slab view may then be reviewed by a clinician either by comparison to their own “mental” set of reference images representing different disease states, or alternatively by visual comparison to a set of reference images presented to the clinician that are representative of patients having different disease states.

To facilitate these comparisons, it is important to minimize any visual differences between images being compared (here, the slab view and the reference images) that are due to differences in scanner hardware (e.g., resolution, sensitivity) and reconstruction protocol (e.g., reconstruction algorithm, scatter correction method etc). Such differences can significantly impact the measured uptake in the striatum, and therefore clinical interpretation, even following conventional background-normalization.

Clinical guidelines advise that the same scanner hardware and reconstruction protocol combination (this combination may be referred to hereinafter as a ‘system’) should be used for patient studies that are compared, e.g. for monitoring a response to therapy. If such an approach is followed, no further standardization would be required; however, in practice it is often infeasible with different sites having different hardware and software systems, along with different preferences for reconstruction. Furthermore, for the case of comparison to reference images of disease states, it would either restrict patient images to be acquired and reconstructed on a specific system, or require the reference images be provided for every combination of hardware and software. Clearly, neither option is practical.

An alternative approach would be to use a technology such as described in UK patent application GB2469569 which applies a phantom-derived filter to align the quantitative (i.e., contrast recovery) performance of a scanner/reconstruction combination to a global standard. This method, however, is designed to standardize quantitative performance across systems rather than facilitate visual comparison between reference and patient images acquired on different systems, which is an aim of the present invention.

### SUMMARY OF THE INVENTION

A method according to an exemplary embodiment of the present invention includes the following:
1. Prior to patient imaging, the image quality performance of the scanner/reconstruction combination used to generate the reference images (hereinafter referred to as ‘system A’) is characterized using a reference object, hereafter referred to as a phantom, for example, a NEMA (National Electrical Manufacturers Association) image quality phantom. The image quality performance may be measured as a function of contrast recovery, and/or noise, for example.
2. The image quality performance of the scanner/reconstruction combination used for patient imaging (hereinafter referred to as ‘system B’) is also characterized using the same reference object as for the previous step, and the same metrics, for example contrast recovery, and/or noise, for example.
3.Post-processing methods are optimized to enable alignment of image quality of the images acquired on ‘system B’ and the reference images acquired on ‘system A’. Such post processing methods may include Gaussian filtering or iterative deconvolution.

Such post-processing methods are then applied to reconstructed patient image(s) from ‘system B’ to align image quality to the reference image(s) from ‘system A’.

Alternatively, the post-processing methods may be applied to the reconstructed reference image(s) from ‘system A’ to align image quality to the patient image(s) from ‘system B’.

In another alternative, the post-processing methods can be applied to both the reference image(s) from ‘system A’, and the patient image(s) from ‘system B’ to align image quality.

The window-level or LUT (Look Up Table) used to display the patient image data from ‘system B’ could be adjusted to improve visual comparability with the reference image(s) from ‘system A’. Alternatively, the window-level or LUT used to display the reference image(s) from ‘system A’ could be adjusted to improve visual comparability with the patient image from ‘system B’.

### DESCRIPTION OF THE PREFERRED EMBODIMENTS

The present invention can be explained considering the following scenario. In this case, reference images are acquired on a state-of-the-art system, producing images with high contrast recovery and fine texture. However, patient images are acquired on an older system, producing smoother images with lower contrast recovery.

According to certain embodiments of the present invention, one or more of the following options may be provided to facilitate visual comparison between such combination of reference and patient images:
1. Smooth the reference images with a Gaussian filter of FWHM (Full Width Half Maximum) selected to align the contrast recovery from ‘system A’ with that from ‘system B’.
2. Iteratively deconvolve the patient images of ‘system B’ to enhance the contrast recovery in line with that of the reference images of ‘system A’.
3. Apply a combination of Gaussian filtering to reference images from ‘system A’ and deconvolution to patient images from ‘system B’ to produce respective images with an intermediate, but aligned, contrast recovery, according to the preference of the reading clinician.
4. Decrease the maximum (‘top’) value of the window level used to display the patient image, to account for the decreased recovery of ‘system B’ relative to ‘system A’, thereby aligning the maximum values for patient image and reference image. This will result in a modification of the mapping between voxel intensity and display color in the patient image.
5. Increase the maximum (‘top’) value of the window level used to display the reference images to account for the increased recovery of ‘system A’ relative to ‘system B’, thereby aligning the maximum values for patient image and reference image. This will result in a modification of the mapping between voxel intensity and display color in the reference image.

Such options are not exhaustive, and alternative post-processing techniques could be applied to align the image quality of images produced by the two systems. For example, non-Gaussian smoothing filters, alternative deconvolution or de-noising methods etc.

Multiple versions of the reconstructed reference images could be stored and made available which may improve the ability of the invention to align image quality of the reference and patient images. The discussed post-processing techniques may be applied to such multiple versions. The multiple versions may be reconstructed with, for example, different algorithms or numbers of iterations/subsets/counts etc.

The methodology of the present invention could be applied to images from other nuclear medicine procedures in which comparison to a set of reference images of different disease states is desirable.

The invention also encompasses a computerized system for processing and displaying patient images obtained using a first scanner/reconstruction protocol combination (‘system’) for comparison with reference images of different disease states acquired on a scanner using a second scanner/reconstruction protocol combination (‘system’). An image quality performance of the second system is characterized using a reference object, hereafter referred to as a phantom. An image quality performance of the first system is characterized using the same phantom. The phantom-derived characterization of image quality performance of the respective protocols may then be used to:
determine a post-processing method (e.g. convolution filter) able to align the image quality from the first system with that from the second system to improve visual comparability; or
determine a post-processing method (e.g., deconvolution filter) able to align the image quality from the second system with that from the first system to improve visual comparability; or
determine a modification of the mapping between voxel intensity and display color to align the visual display of data from the first protocol with the data from the second protocol.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method of facilitating comparison of medical image data captured using first and second systems, each system comprising a combination of a scanner and a reconstruction protocol, comprising:
operating a medical imaging device to obtain image data from a scan of a reference object using the first system;
operating the medical imaging device to obtain image data from a scan of the reference object using the second system;
in a processor, comparing the image data of the first system with the image data of the second system;
in said processor, determining a modifier usable to reduce a difference between the image data of the first system and the image data of the second system; and
in said processor, using the modifier to modify image data of a first subject captured using the first system to reduce a difference from image data of a second subject captured using the second system.

2. A method according to claim 1, wherein comparing and determining the modifier comprise iteratively optimizing one or more post-processing methods to align the image quality of the image data from the first system and the image data from the second system.

3. A method according to claim 1, wherein the modifier comprises at least one of: a smoothing filter; a deconvolution filter; and a window level or look-up table used to display image data from a respective first or second system.
